(19) United States
(12) Patent Application Publication
(10) Pub. No.: US 2026/0153147 A1
(43) Pub. Date: Jun. 4, 2026

(54) SHIFT LOCK RELEASE TOOL

(71) Applicant: NISSAN NORTH AMERICA, INC., Franklin, TN (US)

(72) Inventor: Ian Alejandro BOUQUET BAUTISTA, Toluca (MX)

(21) Appl. No.: 18/965,619

(22) Filed: Dec. 2, 2024

(51) Int. Cl. F16H 63/34; F16H 59/10

(52) U.S. Cl. CPC F16H 63/3491; F16H 59/10

(57) ABSTRACT

Shifting systems for automatic transmissions are disclosed herein. In an embodiment, the shifting system includes a gear selection stick, a cover, a release button and a button release tool. The cover surrounds the gear selection stick and includes a release button aperture. The release button is located within the cover and configured to release the gear selection stick from a locked configuration. The button release tool is stored within the release button aperture and has a keyed portion cooperating with the release button aperture so that the button release tool fits into the release button aperture (i) in a stored position in which the button release tool is prevented from contacting the release button and (ii) in a use position in which the button release tool is enabled to actuate the release button to release the gear selection stick from the locked configuration.

### BACKGROUND

### Field of the Disclosure

The present disclosure generally relates to a shifting system for a vehicle with an automatic transmission. More specifically, the present disclosure generally relates to a shift lock release tool configured to unlock a gear selection stick when the vehicle does not have power.

### Background Information

Many vehicles with automatic transmissions are equipped with a shift lock release button that allows a user to manually release the gear selection stick from a locked configuration when the vehicle does not have power due to a dead battery, bad wiring, a missing key, or otherwise. The user may need to change the gears in this situation, for example, to place the vehicle in neutral to be towed or moved.

Existing shift lock release button systems require the user to pry a small cap from the shifter housing with a screwdriver, and then to insert the screwdriver into the opening to press the release button. In practice, this process can be difficult because the user may not know or see exactly where to align the screwdriver to actuate the release button, which can result in frustration and potential damage to other parts of the shifting system mistakenly contacted by the screwdriver.

### SUMMARY

The present disclosure provides a shifting system with a button release tool that is simple to operate and does not require a screwdriver or any other external tool to use.

In view of the state of the known technology, one aspect of the present disclosure is to provide a shifting system for a vehicle with an automatic transmission. The shifting system includes a gear selection stick, a cover, a release button and a button release tool. The cover surrounds the gear selection stick and includes a release button aperture. The release button is located within the cover and configured to release the gear selection stick from a locked configuration. The button release tool is stored within the release button aperture and has a keyed portion cooperating with the release button aperture so that the button release tool fits into the release button aperture (i) in a stored position in which the button release tool is prevented from contacting the release button and (ii) in a use position in which the button release tool is enabled to actuate the release button to release the gear selection stick from the locked configuration.

A second aspect of the present disclosure is to provide another shifting system for a vehicle with an automatic transmission. The shifting system includes a gear selection stick, a cover, a release button and a button release tool. The cover surrounds the gear selection stick and includes a release button aperture. The release button is located within the cover and configured to release the gear selection stick from a locked configuration. The button release tool is stored within the release button aperture and configured to be (i) rotated from a first position to a second position while a portion thereof remains in the release button aperture and (ii) translated into the cover from the second position to actuate the release button and release the gear selection stick from the locked configuration.

A third aspect of the present disclosure is to provide another shifting system for a vehicle with an automatic transmission. The shifting system includes a gear selection stick, a cover, a release button and a button release tool. The cover surrounds the gear selection stick and includes a release button aperture. The release button is located within the cover and configured to release the gear selection stick from a locked configuration. The button release tool includes an elongated protrusion extending into the cover. The button release tool is configured to (i) be stored in a stored position within the release button aperture in which the elongated protrusion is not aligned with the release button, (ii) move from the stored position to an unlocked position in which the elongated protrusion is aligned with the release button, and (iii) move from the unlocked position towards the release button to actuate the release button with the elongated protrusion to release the gear selection stick from the locked configuration.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a top perspective view of an example embodiment of a vehicle shifting system in accordance with the present disclosure;

FIG. 2 is a top plan view of the shifting system of FIG. 1;

FIGS. 3A to 3D are cross-sectional views showing the button release tool of the shifting system of FIG. 1 moving from a stored position to a use position in accordance with the present disclosure;

FIG. 4A and 4B are cross-sectional views of a second example embodiment of a shifting system with a button release tool moving from a stored position to a use position in accordance with the present disclosure;

FIG. 5A and 5B are top plan views of a third example embodiment of a shifting system with a button release tool configured to move between a stored position to a use position in accordance with the present disclosure;

FIG. 6A and 6B are cross-sectional views of a fourth example embodiment of a shifting system with a button release tool moving from a stored position to a use position in accordance with the present disclosure;

FIG. 7A to 7C are cross-sectional views of a fifth example embodiment of a shifting system with a button release tool configured to move between a stored position to a use position in accordance with the present disclosure;

FIG. 8 is a perspective view of a sixth example embodiment of a shifting system with a button release tool configured to move between a stored position to a use position in accordance with the present disclosure; and

FIGS. 9A and 9B are a cross-sectional views of a seventh example embodiment of a shifting system with a button release tool moving from a stored position to a use position in accordance with the present disclosure.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

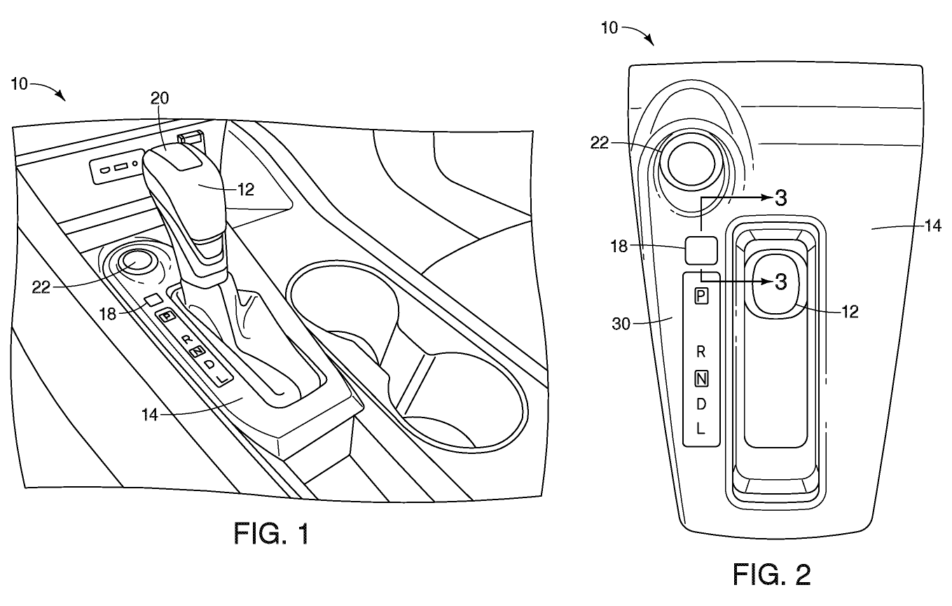

FIGS. 1 to 3 illustrate a first example embodiment of a shifting system 10 for a vehicle with an automatic transmission. In the illustrated embodiment, the shifting system 10 includes a gear selection stick 12, a cover 14, a release button 16 and a button release tool 18. An individual uses the button release tool 18 to manually actuate the release button 16 to unlock the gear selection stick 12 when the vehicle does not have power to unlock the gear selection stick 12 electronically. The vehicle may not have power due to a dead battery, bad wiring, a missing key, or another reason.

The gear selection stick 12 is a standard gear selection stick for an automatic transmission. The gear selection stick 12 protrudes upward from and moves within the cover 14 to allow the driver to put the vehicle in park, reverse, neutral, drive, etc. The gear selection stick 12 typically includes a button 20 actuated by the driver to allow the driver to move the gear selection stick 18 when the vehicle has power. The shifting system 10 of the present disclosure is advantageous, for example, when the driver needs to put the gear selection stick 12 in neutral when the automatic transmission does not have power.

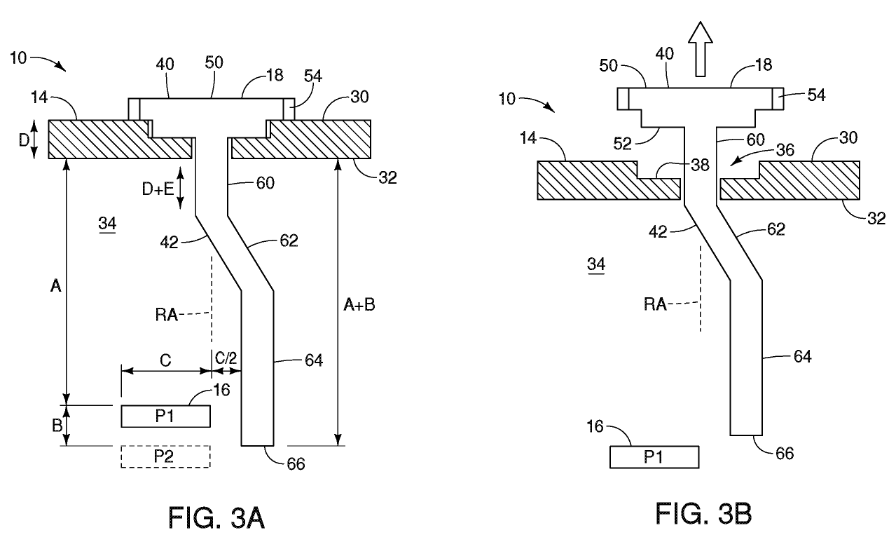

The cover 14 surrounds the gear selection stick 12. The cover 14 includes an upper surface 30 and a lower surface 32, which form an inner space 34 that houses the release button 16 and other components of the shifting system 10, as well as other vehicle components such as an electronic ignition starter 22. As seen in FIGS. 1 and 2, the gear selection stick 12 protrudes from the center of the cover 14 and can be moved back and forth (up/down in FIG. 2) with respect to the cover 14 as understood in the art.

The cover 14 includes a release button aperture 36 configured to receive and store the button release tool 18 therein. The release button aperture 36 extends through the cover 14 between the upper surface 30 and the lower surface 32. In the illustrated embodiment, the release button aperture 36 is located adjacent to the gear selection stick 12. The release button aperture 36 further includes a mating feature 38 configured mate with the button release tool 18 as described in more detail below. In the embodiment illustrated in FIGS. 1 to 3, the mating feature 38 is an indentation in the upper surface 30 of the cover 14. The indentation is sized and shaped in the same way as a lower portion of the button release tool 18.

The release button 16 is configured to release the gear selection stick 12 from a locked configuration when the vehicle does not have power. In the illustrated embodiments herein, the release button 16 is located within the inner space 34 of the cover 14 and moves between a first position P1 and a second position P2. When the release button 16 is in the first position P1, the gear selection stick 12 is locked in its configuration unless electronically unlocked by the vehicle. When the release button 16 moves to the second position P2, the release button 16 unlocks the gear selection stick 12 to be manually moved by an individual. In the illustrated embodiments, the release button 16 is pushed in an actuating direction to move from the position P1 to the position P2. In the illustrated embodiments, the actuating direction is shown to be vertical for convenience, but in practice the actuating direction, the release button 16, the upper surface 20 of the cover 14 and/or the other elements shown may be positioned at an angle.

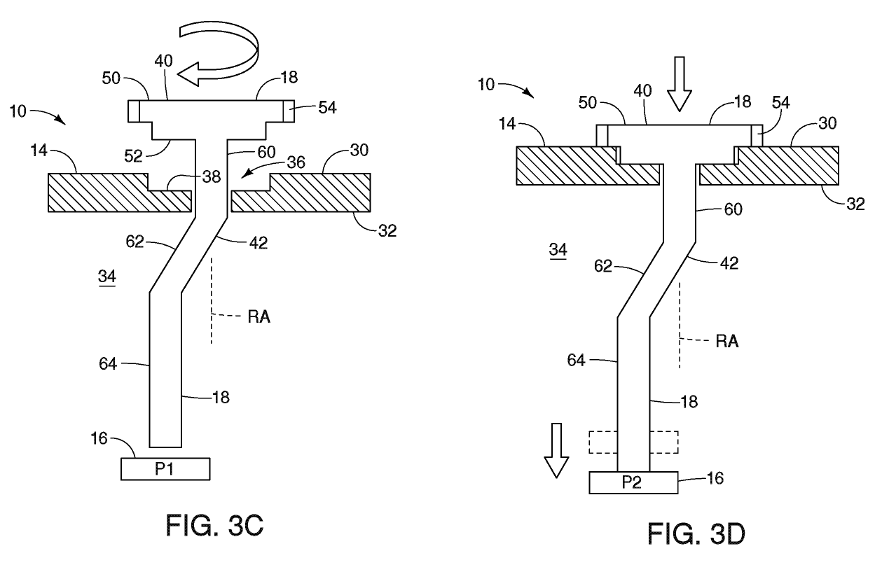

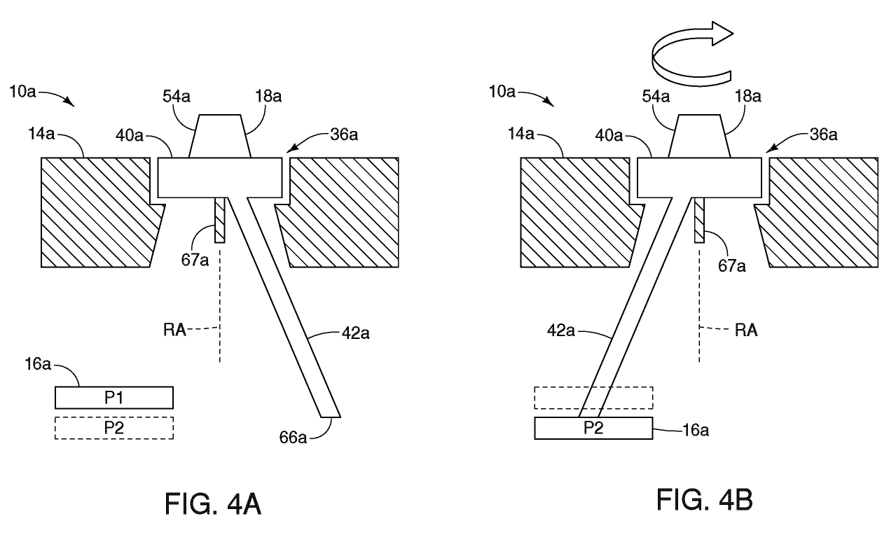

In the illustrated embodiments herein, the release button 16 is offset from the release button aperture 36. For example, as seen in FIG. 3A, the release button 16 is located entirely to the left of center axis of the release button aperture 36, which corresponds to the rotational axis RA of the button release tool 18. Thus, in the illustrated embodiment of FIGS. 3A to 3D, the release button 16 if offset in the radial direction from the center axis of the release button aperture 36 and the rotational axis RA of the button release tool 18, while still partially overlapping the release button aperture 36 in the axial direction of the rotational axis RA. In other embodiments, the release button 16 can be entirely or almost entirely offset from the release button aperture 36, such that the release button 16 does not overlap with much or any of the release button aperture 36 in the axial direction, as seen for example in the embodiment of FIGS. 4A to 4B.

The button release tool 18 fits into the release button aperture 36 in a stored position and a use position. In the stored position, the button release tool 18 is prevented from contacting the release button 16. In the use position, the button release tool 18 is used to manually actuate the release button 16 to release the gear selection stick 12 from a locked configuration. When not being used to actuate the release button 16, the button release tool 18 is stored within the release button aperture 36 in the stored position.

As seen in FIGS. 3A to 3D, the button release tool 18 has a first (top) and a second (bottom) end. The button release tool 18 includes a cap 40 at the first end and an elongated protrusion 42 at the second end. The cap 40 is configured to be gripped by a user, while the elongated protrusion 42 is configured to contact and actuate the release button 16 when needed to release the gear selection stick 12 from the locked configuration.

In the illustrate embodiment, the cap 40 includes a first or upper gripping portion 50 and a second or lower keyed portion 52. The gripping portion 52 includes a gripping material 54 (e.g., rubber) on the surface thereof enabling a person to grip and rotate the button release tool 18. The gripping portion 52 can also include an indentation or other feature that makes it easier for the user to pull up from the release button aperture 36. The keyed portion 52 cooperates with the release button aperture 36 so that the button release tool 18 fits into the release button aperture 36 in different configurations when in the stored position and the unlocked or use positions. FIGS. 3A to 3D illustrate an embodiment in which the gripping portion 50 is wider than the keyed portion 52 so as to rest on the upper surface 30 of the cover 14, while FIGS. 4A and 4B illustrate another embodiment in which the keyed portion 52a is wider than the gripping portion 50a.

Various embodiments of keyed portions 52 are discussed herein. The keyed portion 52 can be formed by an asymmetrical cap 40. The keyed portion 52 can be formed by cap 40 that is only symmetrical through one center line (i.e., can only be divided into mirrored halves along one line of symmetry). For example, the keyed portion 52 can have an outer shape that only allows the cap 40 to fit into the mating feature 38 in two configurations, i.e., the stored position and the unlocked or use position. In an embodiment, the keyed portion 52 only mates with the mating feature 38 in the stored position and the unlocked or use position and will not otherwise fit properly in the mating feature 38. The keyed portion 52 can also include one of a protrusion or an indentation that is configured to mate with the other of a corresponding protrusion or indentation in the mating feature 38.

The elongated protrusion 42 extends from the cap 40 through the release button aperture 36 and into the cover 14 and contacts the release button 16 to actuate the release button 16. As seen in FIGS. 3A to 3D, the elongated protrusion 42 extends downwardly at an angle from the cap 40 into the inner space 34 of the cover 14. In the illustrated embodiment, the elongated protrusion 42 includes a first portion 60, a second portion 62 and a third portion 64. The first portion 60 extends through the release button aperture 36 in the axial direction of the rotational axis RA. The second portion 62 extends downwardly from the first portion 60 at an angle with respect to the cover 14 and the rotational axis RA. The third portion 64 extends downwardly from the second portion 62 in the axial direction of the rotational axis RA and includes a contact point 66 configured to contact the release button 16 to unlock the gear selection stick 12. Those of ordinary skill in the art will recognize from this disclosure that other shapes can be used to achieve the same goal. For example, the second embodiment of FIGS. 4A and 4B has an elongated protrusion 42a that is entirely angled downwardly from the cap 40a.

FIGS. 3A to 3D illustrate an example embodiment of the button release tool 18 moving from the stored position (or first position) to an unlocked position (or second position) in which the elongated protrusion 42 is aligned with the release button 16. In use, the button release tool 18 is configured to rotate around the rotational axis RA to move into alignment with the release button 16. Once the button release tool 18 is aligned with the release button 16, the button release tool 18 is configured to move further into the cover 14 (downward in FIGS. 3C and 3D) to actuate the release button 16. The elongated protrusion 42 remains within the release button aperture 36 as the button release tool 18 moves from the stored position to the unlocked position, and vice versa. This way, the button release tool 18 cannot be misplaced by the owner of the vehicle.

In FIG. 3A, the button release tool 18 is in the stored position with the cap 40 resting within the mating feature 38 in the cover 14, and with the elongated protrusion 42 extending through the release button aperture 36 and into the inner space 34. In this configuration, the button release tool 18 is not aligned with the release button 16. More specifically, the contact point 66 at the end of the elongated protrusion 42 is not aligned with the release button 16. Rather, the second portion 62 of the elongated protrusion 42 angles away from the rotational axis RA of the button release tool 18 in the opposite direction of the release button 16 so that the contact point 66 cannot actuate the release button 16. The elongated protrusion 42 moves into alignment with the release button 16 when the button release tool 18 rotates into the unlocked position shown in FIG. 3C.

FIG. 3B illustrates the button release tool 18 after it has been moved from the stored position to an intermediate position. In this intermediate position, the button release tool 18 has been translated in a first direction (upwardly in the axial direction of the rotational axis RA in FIGS. 3A and 3B) from the stored position, such that the contact point 66 of the elongated protrusion 42 moves to a vertical position higher than the release button 16 but remains unaligned with the release button 16.

FIG. 3C then illustrates the button release tool 18 in a unlocked position after being rotated from the intermediate position around the rotational axis RA to align the contact point 66 with the release button 16. In FIG. 3C, the contact point 66 is located above the release button 16 (e.g., aligned with the release button 16 in the axial direction of the rotational axis RA) such that manually translating the cap 40 of the button release tool 18 towards the cover 14 will cause the contact point 66 of the elongated protrusion 42 to push the release button 18 from the first position P1 to the second position P2. In the illustrated embodiment, the button release tool 18 rotates approximately 180 degrees between the intermediate position and the unlocked position. In alternative embodiments, the button release tool 18 can be configured to rotate other amounts between the stored and unlocked or use positions, for example, 45 degrees, 90 degrees, etc.

The button release tool 18 is then configured to move from the unlocked position towards the release button 16 to actuate the release button 16 with the elongated protrusion 42, which releases the gear selection stick 12 from the locked configuration. More specifically, the button release tool 18 is configured to be translated into the cover 14 from the unlocked position into a use position which actuates the release button 16 and releases the gear selection stick 12 from the locked configuration. FIG. 3D illustrates the button release tool 18 in the use position, after the button release tool 18 has translated from the unlocked position and actuated the release button 16. As seen in FIG. 3D, the button release tool 18 moves from the unlocked position in a second direction opposite the first direction (e.g., downwardly in the axial direction of the rotational axis RA in FIGS. 3C and 3D) to cause the contact point 66 to actuate the release button 16 by pushing the release button 16 to the position P2

Thus, in the embodiment illustrated in FIGS. 3A to 3D, the button release tool 18 translates away from the cover 14 in a first direction (FIGS. 3A to 3B) to an intermediate position, then rotates with respect to the cover 14 from that intermediate position to the unlocked position (FIGS. 3B to 3C), and then then translates back towards the cover 14 in a second direction opposite the first direction to the use position (FIGS. 3C to 3D). To place the button release tool 18 back in the stored position after actuating the release button 16, a user manually executes the reverse process. That is, the user translates the button release tool 18 away from the cover 14 in the first direction (FIGS. 3D to 3C), then rotates the button release tool 18 with respect to the cover 14 from that unlocked position back to the intermediate position (FIGS. 3C to 3B), and then then translates the button release tool 18 back towards the cover 14 in the second direction and into the stored position (FIGS. 3B to 3A).

In the illustrated embodiment, the button release tool 18 is optimally dimensioned to perform its function. FIG. 3A illustrates example dimensions. Here, the release button 16 is located a distance A from the bottom surface 32 of the cover 14. The release button 16 moves a distance B when moving from the first position P1 to the second position P2. The length of the release button 16 is a distance C. The cover 14 has a thickness of a distance D. The length of the first portion 60 of the elongated protrusion 42 to the second portion 62 that is angled is a distance D+E. Here, E is a tolerance that ensures that the button release tool 18 can move far enough away from the cover 14 to align the contact point 66 with the release button 16. The overall distance between the bottom surface 32 of the cover 14 and the contact surface 66 of the elongated protrusion is A+B to ensure that the elongated protrusion 42 is long enough to push the release button 16 from the first position P1 to the second position P2. The third portion 64 of the elongated protrusion 42 is approximately a distance C/2 away from the rotational axis RA to make sure that the contact point 66 does not strike the release button 16 unless intended by a user. Those of ordinary skill in the art will recognize from this disclosure that these are example dimensions and that the button release tool 18 can also perform its function of actuating the release button 14 with other dimensions.

FIGS. 4A and 4B illustrate a second example embodiment of a shifting system 10a, with similar reference numbers used to identify common elements with the first embodiment of the shifting system 10. Like the shifting system 10, the shifting system 10a includes a gear selection stick 12 (as seen in FIGS. 1 and 2), a cover 14a, a release button 16a, and a button release tool 18a. The cover 14a includes a release button aperture 36a, and the button release tool 18a includes a cap 40a and an elongated protrusion 42a. Here, the cap 40a includes a gripping portion 54a, and the elongated protrusion 42a extends entirely at an angle from the cap 40a and though the release button aperture 36a to a contact point 66a.

FIG. 4A illustrates the button release tool 18a in the stored position, and FIG. 4B shows the button release tool 18a in the use position. Here, the button release tool 18a is attached to a rotational point 67a in the cover 14a. The rotational point 67a is aligned with the rotational axis RA of the button release tool 18a, such that the button release tool 18a rotates around the rotational point 18a to achieve the use position and actuate the release button 18a.

In one embodiment, the button release tool 18a is operated similar to the button release tool 18 of FIGS. 3A to 3D. That is, the button release tool 18a can be configured to translate vertically back and forth along the rotational axis RA of the rotational point 67a. As with the button release tool 18 of FIGS. 3A to 3D, the button release tool 18a can translate in a first direction (here, upward) from the stored position shown in FIG. 3A to an intermediate position (not shown), then rotate from the intermediate position to an unlocked position (not shown) to align the contact point 66a with the release button 16a, and then translate in a second direction (here, downward) opposite the first direction to move into the use position (FIG. 4B), which pushes the release button 16a from the first position P1 to the second position P2. To place the button release tool 18a back in the stored position after actuating the release button 16a, a user manually executes the reverse process. Alternatively, the shifting system 10a can be configured so that the user does not need to translate the button release tool 18a in the first or second direction (here, upward or downward) to move back to the stored position. For example, in an embodiment, the user can simply rotate the button release tool 18a from the use position (FIG. 4B) to the stored position (FIG. 4A), such that the contact point 66a slides off the release button 16a as the button release tool 18a rotates. In an embodiment, the button release tool 18a is biased towards the stored position, so that the button release tool 18a automatically rotates back to the stored position after actuating the release button 16a and being released by the user.

In another embodiment, the button release tool 18a can actuate the release button 16a by rotating from the stored position shown in FIG. 4A to the use position shown in FIG. 4B, without translating in the first or second directions (here, upward or downward) with respect to the cover 14a. In this embodiment, the release button 16a and/or the elongated protrusion 42a can include a ramp or another feature that causes the release button 16a to translate from the first position P1 to the second position P2 as the contact point 66a of the elongated protrusion 42a rotates into and slides across the upper surface of the release button 16a. In an embodiment, the button release tool 18a can be biased back towards the stored position, so that the user rotates the button release tool 18a against the biasing force when moving from the stored position to the use position, and so that the button release tool 18a automatically rotates back to the stored position after actuating the release button 16a and being released by the user.

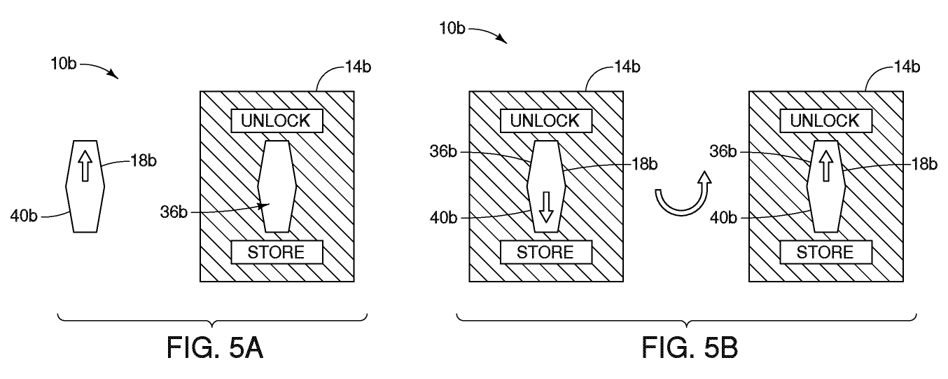

FIGS. 5A and 5B illustrate a third example embodiment of a shifting system 10b, with similar reference numbers used to identify common elements with the other embodiments of the shifting systems 10, 10a. Like the shifting system 10, the illustrated shifting system 10b includes a gear selection stick 12 (as seen in FIGS. 1 and 2), a cover 14b, a release button 16 (as seen in the other Figures), and a button release tool 18b. As seen in FIG. 5A, the button release tool 18b includes a cap 40b which fits into a similarly shaped release button aperture 36b in the cover 14b. As seen in FIG. 5B, the shape of the cap 40b only allows the cap 40b to fit into the release button aperture 36b in two configurations. The cover 14b further includes indicators for the two orientations. As illustrated, when the arrow on the cap 40b points downward, the button release tool 18b is in the stored position (e.g., as shown in FIGS. 3A and 4A), and when the arrow on the cap 40b points upward, the button release tool 18b is in the unlocked or use position (e.g., as shown in FIGS. 3C, 3D or 4B). The button release tool 18b is prevented from translating into the cover 14b in any other orientation due to the shape of the cap 40b. In the illustrated embodiment, a user rotates the cap 40b into the unlocked position shown in FIG. 5B and then presses the cap 40b into the cover 14b to actuate the release button 16 and release the gear selection stick 12.

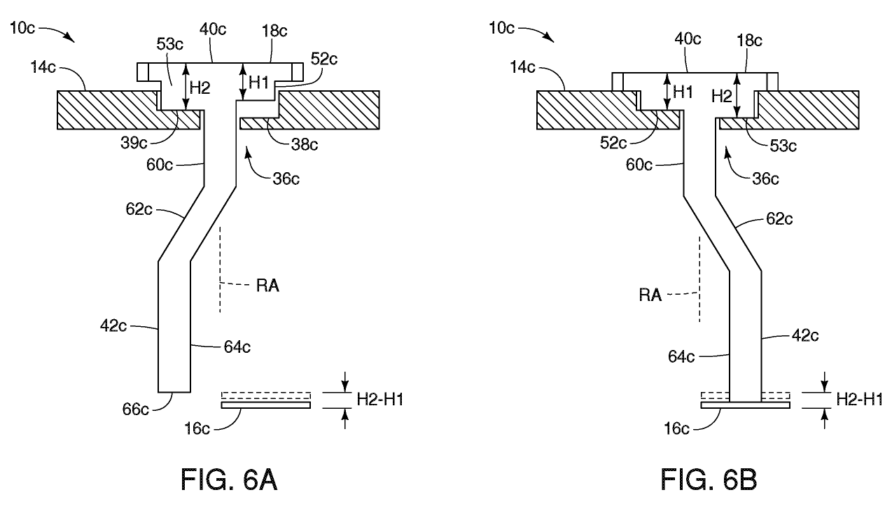

FIGS. 6A and 6B illustrate a fourth example embodiment of a shifting system 10c, with similar reference numbers used to identify common elements with the other embodiments of the shifting systems 10, 10a, 10b. Like the shifting system 10, the illustrated shifting system 10c includes a gear selection stick (as seen in FIGS. 1 and 2), a cover 14c, a release button 16c, and a button release tool 18c. Here, the button release tool 18c includes a cap 40c and a longitudinal extension 42c having a first portion 60c, an angled second portion 62c, and a third portion 64c extending to a contact point 66c. FIG. 6A shows the shifting system 10c in the stored position, while FIG. 6B shows the shifting system 10c in the use position. The shifting system 10c is configured to move from the stored position to the use position by moving as described herein with the other embodiments.

In the fourth embodiment, the lower side of the cap 40c includes a first keyed feature 52c and a second keyed feature 53c, and the upper surface of the cover 14c has a corresponding first mating feature 38c and a second mating feature 39c. The first keyed feature 52c has a height H1, while the second keyed feature 52c has a height H2 that is different from the first height H1. Here, the second height H2 is longer than the first height H1. The first mating feature 38c and the second mating feature 39 include corresponding height indentations with the first mating feature 38c extending deeper into the cover 14c than the second mating feature 39c. The elongated portion 42c can only actuate the release button 16c if the first keyed feature 52c is aligned with the first mating feature 38c and the second keyed feature 53c is aligned with the second mating feature 39c. FIG. 6B illustrates that only when these features are aligned is the button release tool 18c able to actuate the release button 16c. This type of keying indicates to the user that the button release tool 18c is not in the right position to actuate the release button 16c if the button release tool 18c does not fit all the way into the cover 14c.

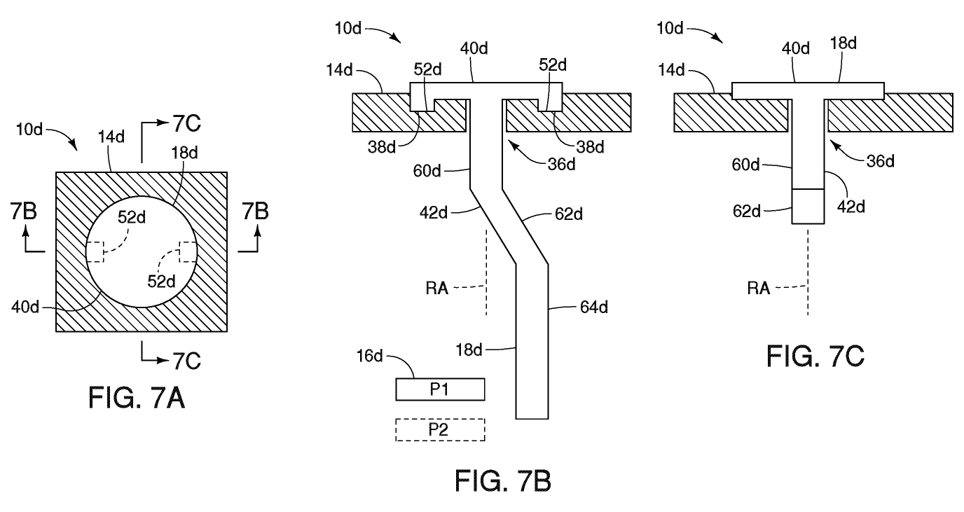

FIGS. 7A to 7C illustrate a fifth example embodiment of a shifting system 10d, with similar reference numbers used to identify common elements with the other embodiments of the shifting systems 10, 10a, 10b, 10c. Like the shifting system 10, the illustrated shifting system 10d includes a gear selection stick (as seen in FIGS. 1 and 2), a cover 14d, a release button 16d, and a button release tool 18d. Here, the button release tool 18d includes a cap 40d and a longitudinal extension 42d having a first portion 60d, an angled second portion 62d, and a third portion 64d extending to a contact point 66d. FIGS. 7A to 7C show the shifting system 10d in the stored position.

In the fifth embodiment, the lower side of the cap 40d includes opposite keyed features 52d located on opposite ends, and the upper surface of the cover 14d has corresponding mating features 38d. Here, the keyed features 52d are downward protrusions, and the mating features 38d are corresponding indentations in the cover 14d, but the opposite configuration can also be used with the keyed features 52d being the indentations and the mating features 38d being the protrusions. Similar to the shifting system 10b shown in FIGS. 5A and 5B, the shape of the cap 40d only allows the cap 40d to fully fit into the release button aperture 36d in two configurations. The button release tool 18d is prevented from translating into the cover 14d in any other orientation due to the shape and location of the opposite keyed features 52d and corresponding mating features 38d.

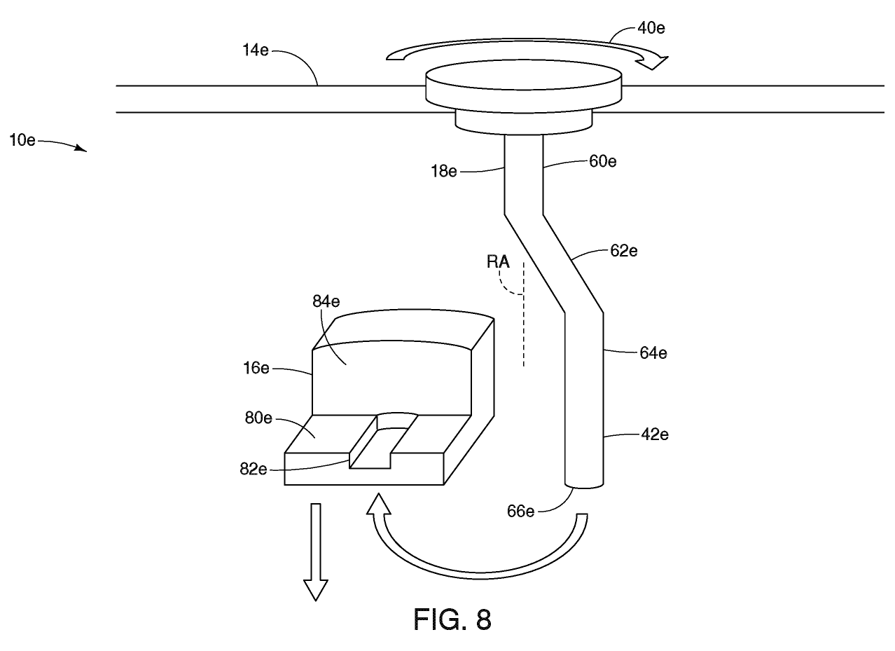

FIG. 8 illustrates a sixth example embodiment of a shifting system 10e, with similar reference numbers used to identify common elements with the other embodiments of the shifting systems 10, 10a, 10b, 10d. Like the shifting system 10, the illustrated shifting system 10e includes a gear selection stick (as seen in FIGS. 1 and 2), a cover 14e, a release button 16e, and a button release tool 18e. Here, the button release tool 18e includes a cap 40e and a longitudinal extension 42e having a first portion 60e, an angled second portion 62e, and a third portion 64e extending to a contact point 66e. In this embodiment, the release button 16e includes a lateral surface 80e, a first button catching feature 82e, and a second button catching feature 84e. In the illustrated embodiment, the first button catching feature 82e is a channel in the lateral surface 80e, and the second button catching feature 82e is a protruding wall (here, protruding upward from the lateral surface 80e).

In the sixth embodiment, the first button catching feature 82e and/or the second button catching feature 82e ensure that the button release tool 18e is not over-rotated by the user. As the user rotates the button release tool 18e into the release button 16e, the third portion 64e extends into the channel of the first button catching feature 82e until it strikes the protruding wall of the second button catching feature 84e. The user can then press downward on the cap 40e to actuate the release button 16e.

In one embodiment, the shifting system 10e is operated similar to the shifting system 10, with the user translating the button release tool 18e away from the cover 18e to an intermediate position, rotating the button release tool 18e to an unlocked position, and then translating the button release tool 18e toward the cover 18e to actuate the release button 16e. In this embodiment, the channel of the first button catching feature 82e can be made deep enough so that the contact point 66e protrudes into the channel when the button release tool 18e is located further away from the cover 18e in the unlocked position, and/or the wall of the second button catching feature 84e can be made tall enough that the contact point 66e strikes the wall when the button release tool 18e is located further away from the cover 18e in the unlocked position.

In another embodiment, the shifting system 10e is operated by only rotating the button release tool 18e without translating away from the cover 14e. For example, the channel of the first button catching feature 82e can include a ramp or angled surface that angles upwardly toward the rear (e.g., from the front towards the wall of the second button catching feature 84e in FIG. 8). As the button release tool 18e rotates over the release button 16e, the contact point 66e translates across the ramp and gradually pushes the release button 16e downward to the second position P2 to release the gear selection stick 12. In an embodiment, the button release tool 18e is biased towards the stored position, so that the button release tool 18e automatically rotates back to the stored position after actuating the release button 16e and being released by the user.

Those of ordinary skill in the art will recognize from this disclosure that only one of the first button catching feature 82e and the second button catching feature 82e can be sufficient to catch/stop the button release tool 18e, such that both are not required.

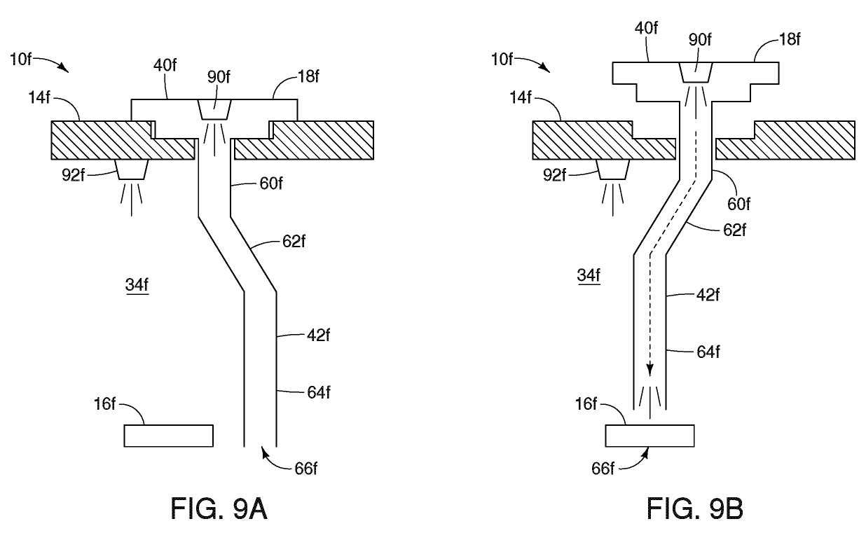

FIGS. 9A and 9B illustrate a seventh example embodiment of a shifting system 10f with similar reference numbers used to identify common elements with the other embodiments of the shifting systems 10, 10a, 10b, 10c, 10e. Like the shifting system 10, the illustrated shifting system 10f includes a gear selection stick (as seen in FIGS. 1 and 2), a cover 14f, a release button 16f, and a button release tool 18f. Here, the button release tool 18f includes a cap 40f and an elongated protrusion 42f having a first portion 60f, an angled second portion 62f, and a third portion 64f extending to a contact point 66f.

In the seventh embodiment, the button release tool 18f includes first light 90f, and the bottom surface of the cover 14f includes a second light 92f. The elongated protrusion 42f is hollow to allow light from the first light 90f to illuminate the release button 16f when the contact point 66f is aligned with the release button 16f. Similarly, the second light 92f illuminates the release button 16f if needed. In this embodiment, the cover 14f can be transparent or semi-transparent to allow the user to use the light to see when the contact point 66f is aligned with the release button 16f. Alternatively, the user can look through the aperture receiving the elongated protrusion 42f or another aperture to view the illuminated release button 16f. Those of ordinary skill in the art will recognize from this disclosure that only one of the first light 90f and the second light 92f can be sufficient to illuminate the release button 16f, such that both are not required. In an embodiment, the light(s) 90f, 92f only turn on when a user moves the button release tool 18f.

Those of ordinary skill in the art will recognize from this disclosure that any of the features of the example embodiments of the shifting systems 10, 10a, 10b, 10c, 10e, 10f disclosed herein can be applied to any of the other shifting systems 10, 10a, 10b, 10c, 10e, 10f. Those of ordinary skill in the art will also recognize from this disclosure that certain elements of the example embodiments of the shifting systems 10, 10a, 10b, 10c, 10e, 10f disclosed herein can be omitted, altered or added without departing from the spirit or scope of the present disclosure.

In an embodiment, a biasing mechanism such as a spring can be added to the example embodiments of the shifting systems 10, 10a, 10b, 10c, 10e, 10f disclosed herein. For example, a spring can be used to bias the button release tool 18 away from the release button 16, such that a user pushes the button release tool 18 into the cover 14 against the biasing force to actuate the release button 16. Using a biasing mechanism in this manner can prevent the button release tool 18 from accidentally actuating the release button 16 when not intended.

The embodiments described herein provide improved systems, methods and devices for unlocking a shifting system for an automatic transmission. These systems and methods are advantageous, for example, because the vehicle occupant does not need extra tools such as a screwdriver to unlock the shifting system. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

WHAT IS CLAIMED IS:

1. A shifting system for a vehicle with an automatic transmission, the shifting system comprising:
a gear selection stick;
a cover surrounding the gear selection stick and including a release button aperture;
a release button located within the cover and configured to release the gear selection stick from a locked configuration; and
a button release tool stored within the release button aperture and having a keyed portion cooperating with the release button aperture so that the button release tool fits into the release button aperture (i) in a stored position in which the button release tool is prevented from contacting the release button and (ii) in a use position in which the button release tool is enabled to actuate the release button to release the gear selection stick from the locked configuration.

2. The shifting system of claim 1, wherein
the button release tool has a first end and a second end,
the first end includes a cap having a gripping portion enabling a vehicle occupant to grip and rotate the button release tool, and
the second end includes an elongated protrusion extending from the cap into the cover and contacting the release button when the button release tool actuates the release button.

3. The shifting system of claim 2, wherein
at least a portion of the elongated protrusion extends at an angle with respect to the cover.

4. The shifting system of claim 1, wherein
the release button is offset from the release button aperture in a horizontal direction.

5. The shifting system of claim 1, wherein
the keyed portion includes an asymmetrical cap.

6. The shifting system of claim 1, wherein
the release button aperture includes a mating feature that mates with the keyed portion of the button release tool, and
the keyed portion only mates with the mating feature in the stored position and the use position.

7. The shifting system of claim 6, wherein
the mating feature includes an indentation in the release button aperture that receives the keyed portion of the button release tool.

8. A shifting system for a vehicle with an automatic transmission, the shifting system comprising:
a gear selection stick;
a cover surrounding the gear selection stick and including a release button aperture;
a release button located within the cover and configured to release the gear selection stick from a locked configuration; and
a button release tool stored within the release button aperture and configured to be (i) rotated from a first position to a second position while a portion thereof remains in the release button aperture and (ii) translated into the cover from the second position to actuate the release button and release the gear selection stick from the locked configuration.

9. The shifting system of claim 8, wherein
before the button release tool rotates from the first position to the second position, the button release tool translates away from the cover in a first direction from a stored position to the first position while the portion thereof remains in the release button aperture.

10. The shifting system of claim 9, wherein
the button release tool moves in a second direction opposite the first direction when translating into the cover from the second position to actuate the release button.

11. The shifting system of claim 8, wherein
the button release tool rotates approximately 180 degrees between the first position and the second position.

12. The shifting system of claim 8, wherein
the button release tool includes a cap and an elongated protrusion extending from the cap into the cover, and
the release button includes a catching surface which prevents the elongated protrusion from rotating past the second position when the button release tool rotates from the first position to the second position.

13. The shifting system of claim 12, wherein
the catching surface includes at least one of a channel or a cup shape.

14. The shifting system of claim 8, wherein
the button release tool includes a cap and an elongated protrusion extending from the cap into the cover, and
the elongated protrusion moves into alignment with the release button when the button release tool rotates from the first position to the second position.

15. A shifting system for a vehicle with an automatic transmission, the shifting system comprising:
a gear selection stick;
a cover surrounding the gear selection stick and including a release button aperture;
a release button located within the cover and configured to release the gear selection stick from a locked configuration; and
a button release tool including an elongated protrusion extending into the cover, the button release tool configured to (i) be stored in a stored position within the release button aperture in which the elongated protrusion is not aligned with the release button, (ii) move from the stored position to an unlocked position in which the elongated protrusion is aligned with the release button, and (iii) move from the unlocked position towards the release button to actuate the release button with the elongated protrusion to release the gear selection stick from the locked configuration.

16. The shifting system of claim 15, wherein
the button release tool is rotated when moving from the stored position to the unlocked position.

17. The shifting system of claim 15, wherein
the button release tool is translated away from the cover when moving from the stored position to the unlocked position.

18. The shifting system of claim 15, wherein
the button release tool includes a cap configured to be gripped by a vehicle occupant, and
the elongated protrusion extends from the cap at an angle.

19. The shifting system of claim 15, wherein
the release button is offset from the release button aperture in a horizontal direction.

20. The shifting system of claim 15, wherein
the button release tool includes a keyed portion cooperating with the release button aperture so that the button release tool fits into the release button aperture in different configurations when in the stored position and the unlocked position.
